(19) United States
(12) Patent Application Publication
(10) Pub. No.: US 2013/0341267 A1
(43) Pub. Date: Dec. 26, 2013

(54) TREATMENT FOR MOLASSES SPENT WASH AND OTHER WASTEWATERS

(71) Applicants: Vijaysai Prasad, Bangalore (IN); Raiendra Prasad Kalakodimi, Bangalore (IN); Alagarsamy Subbiah, Bangalore (IN); Arjun Bhattacharyya, Bangalore (IN); Narain Madhavan, Bangalore (IN)

(72) Inventors: Vijaysai Prasad, Bangalore (IN); Raiendra Prasad Kalakodimi, Bangalore (IN); Alagarsamy Subbiah, Bangalore (IN); Arjun Bhattacharyya, Bangalore (IN); Narain Madhavan, Bangalore (IN)

(73) Assignee: General Electric Company, Schenectady, NY (US)

(21) Appl. No.: 13/876,258

(22) PCT Filed: Sep. 28, 2010
(86) PCT No.: PCT/IN10/00648

§ 371 Date: Sep. 6, 2013

(51) Int. Cl. C02F 3/00; C02F 3/30

(52) U.S. Cl. CPC C02F 3/005; C02F 3/30
USPC 210/605; 210/631

(57) ABSTRACT

Disclosed is a process and apparatus that uses multiple stages or unit processes to treat wastewater, such as distillery spent wash which may be molasses spent wash (MSW). The stages include one or more of anaerobic digestion, chemical treatment, electrocoagulation, aerobic treatment, physical separation, and RO or adsorbent based treatment. A chemical treatment for the effluent from an anaerobic digester treating MSW is described. In an electrocoagulation step, a stable cathode is used to also provide electroflotation and hardness precipitation. Aerobic biological treatment and physical separation may be provided by a membrane bioreactor.

### CROSS REFERENCE TO RELATED APPLICATIONS

This is a national stage application under 35 U.S.C. §371(c) prior-filed, co-pending PCT patent application is serial number IN10/000648, filed on Sep. 28, 2010, the entire contents of which are incorporated herein by reference.

### BACKGROUND OF THE INVENTION

Embodiments of the invention relate to wastewater treatment, treatment of effluents from anaerobic digesters and treatment of distillery spent wash, for example molasses spent wash.

The following is not an admission that anything discussed below is citable as prior art or common general knowledge.

An ethanol distillery may produce over 10 liters of spent wash for every liter of alcohol produced. The spent wash typically has a high chemical oxygen demand (COD), for example 80,000 mg/L or more, and may also contain toxic pollutants, hardness and suspended impurities causing turbidity. Accordingly, the spent wash cannot be safely discharged into the environment. If molasses is used as a raw material in the distillery then the spent wash, called molasses spent wash (MSW), will also be a dark brown color. The color is created by melanoidins, phenolics, caramels and furfurals and is dark enough to reduce photosynthesis in receiving waters. The melanoidins in particular are toxic to some microorganisms used in conventional wastewater treatment processes and difficult to remove.

In India alone, over 40 billion liters of spent wash is produced from about 350 distilleries every year. These distilleries typically use molasses as a raw material. Anaerobic digestion is one treatment method used by distilleries to treat the spent wash since it produces a biogas that may be used to provide heat or power to the distillery. The digester also produces an effluent with a reduced COD concentration. This effluent may also be subjected to aerobic treatment to reduce its biochemical oxygen demand (BOD). However, the COD, suspended solids (SS) and dissolved solids (DS) of the effluent is still too high to conform to regulatory standards of quality required for discharge. Further, the anerobic digester does not remove a significant portion of the melanoidins, caramels and other colorants and the effluent is still a dark brown color. The effluent from distilleries is considered to be one of the highest sources of pollutants by the Central Pollution Control Board of India.

Various attempts have been made to treat the distillery effluent. One approach uses disc reverse osmosis (disc-RO) membranes. This approach has been tried in the field but has not been widely adopted due to maintenance costs, low recovery and problems with reliability. An evaporator-based approach has also been tried in the field but has not been widely accepted due to its cost and susceptibility to corrosion and scaling problems. Research has also been done into adsorption using activated carbon, polyvinyl chloride or cellulose acetate phthalate, nanofiltration followed by RO, using spent wash contaminated soil as an inoculum, and treatments with fungus or other specific micro-organisms. These various ideas range from lab to pilot scale investigations, but have not yet produced any commercially accepted solution.

### BRIEF DESCRIPTION OF THE INVENTION

This section is intended to introduce the reader to the detailed description to follow and not to limit or define any claimed embodiments of the invention.

In an embodiment of the invention, a process for treating effluent from an anaerobic digester fed with molasses spent wash is provided. The process comprises adding flocculant chemicals to the effluent, removing flocs or precipitates from the effluent, and reducing the hardness of the effluent. The process further comprises treating the effluent by aerobic digestion and by membrane separation or adsorption.

In an embodiment of the invention, a process for treating wastewater is also provided. The process comprises adding chemicals to the wastewater to produce flocs in the wastewater and removing the flocs. The process further comprises treating the wastewater by electrocoagulation, in a membrane bioreactor, and by one or more of nanofiltration, reverse osmosis or adsorption.

In an embodiment of the invention, a process for treating effluent from an anaerobic digester is provided. The anaerobic digester is fed with molasses spent wash comprising a step of passing the effluent through an electrocoagulation unit having a stable cathode.

### BRIEF DESCRIPTION OF THE DRAWINGS

FIG. 1 is a schematic process flow diagram of a wastewater treatment plant; and

FIG. 2 is a schematic representation of an electrocoagulation device.

### DETAILED DESCRIPTION OF THE INVENTION

Embodiments of the present invention describe a process and apparatus in which wastewater, such as molasses spent wash digester effluent from a distillery, is treated in multiple stages until it meets discharge requirements or is suitable for reuse. Molasses spent wash is particularly difficult to treat because it contains, among other contaminants, color causing pigments in both soluble and insoluble sizes. However, the process and apparatus described herein may also be used with other wastewaters.

The stages of treatment include one or more of chemical treatment, softening, aerobic digestion, membrane separation and adsorption. In an embodiment to be described in more detail below, the effluent is treated by way of chemical flocculation, electrocoagulation, treatment in a membrane bioreactor and reverse osmosis, in that order. The electrocoagulation step provides softening through precipitation on a stable cathode and removes solids, but may be replaced with lime softening or other softening techniques. The reverse osmosis step may alternatively be replaced by adsorption, nanofiltration or a combination of two or more of reverse osmosis, nanofiltration and reverse osmosis. One or more contaminants are removed with each stage resulting in an effluent suitable for treatment in a downstream stage. The final effluent meets discharge requirements or may be reused. Individual steps, such as the chemical flocculation step and the electrocoagulation step, may also have applications in other process.

Table 1 provides a typical example of the composition of distillery waste measured before and after treatment with an anaerobic digester. Comparing the tables indicates that, except for chemical oxygen demand (COD) and biochemical oxygen demand (BOD), the digester does not significantly decrease the concentrations of contaminants. Further, even though COD and BOD concentrations are reduced, the effluent concentrations shown in table 1B are still too high for discharge. Accordingly, the effluent as described in table 1B requires further treatment, particularly to remove COD, BOD, solids, hardness and color.

TABLE 1
Water analysis of distillery waste before
and after anaerobic digestion

| Parameter | Unit | Before Digester | After Digester |
|---|---|---|---|
| PH | | 3.52 | 7.75 |
| Colour | mg/l | Dark Brown | Dark Brown |
| Odour | mg/l | Non Objectional | Non Objectional |
| Suspended Solids | mg/l | 11840 | 18130 |
| Temperature | ° c. | 27 | 27 |
| Ammonical Nitrogen | mg/l | 26 | 14 |
| Free Ammonia | mg/l | Nil | Nil |
| COD | mg/l | 79200 | 17325 |
| BOD | mg/l | 23760 | 5197 |
| Nitrate Nitrogen | mg/l | 242.71 | 162.62 |
| Volatile Suspended Solids | mg/l | 8122 | 13224 |
| MLSS | mg/l | 9672 | 15221 |
| Total Phosphorous | mg/l | 0.0462 | 0.0248 |
| P-Alkalinity | mg/l | Nil | Nil |
| M-Alkalinity | mg/l | 306.45 | 249.7 |
| Specific Conductance | mg/l | 20100 | 20200 |
| Total Hardness | mg/l | 12500 | 8500 |
| Calcium Hardness | mg/l | 7500 | 7750 |
| Calcium | mg/l | 3006 | 3106.2 |
| Magnesium | mg/l | 1218.2 | 182.73 |
| Sulphur as SO4 | mg/l | 397.9 | 170.91 |
| Chlorides | mg/l | 8687.02 | 7216.9 |
| Total Inorganic | mg/l | 0.0462 | 0.0248 |
| Phosphorous | | | |
| Turbidity | NTU | 64 | 58 |
| Total Organic Carbon | mg/l | 270 | 206 |
| Sulphide as S | mg/l | 240 | 232 |
| Phenolics | mg/l | Nil | Nil |

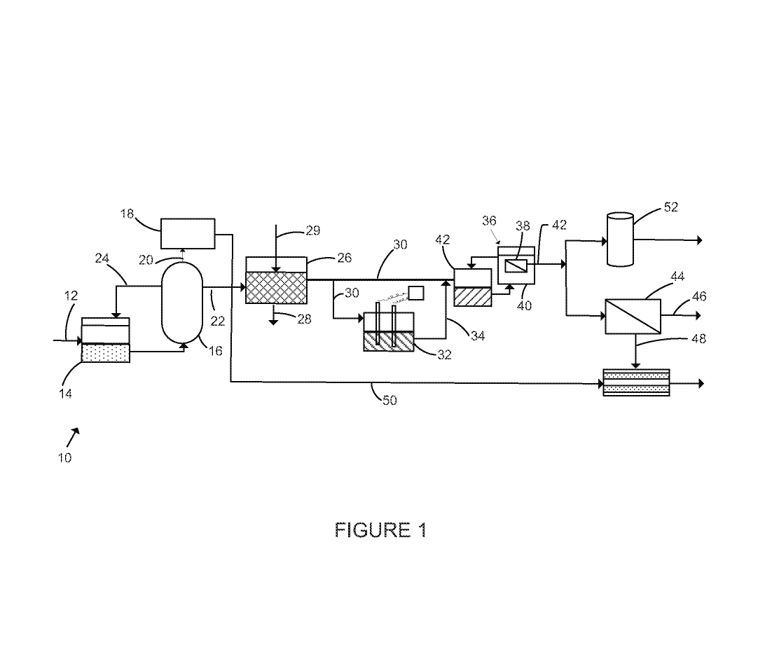

Referring to FIG. 1, a treatment plant 10 passes the spent wash effluent through multiple steps, each reducing the concentrations of one or more impurities until the water is below discharge limits or suitable for reuse. The steps include one or more of anaerobic digestion, alternately called biomethanation, chemical treatment, electrocoagulation or a softening step, biological treatment optionally with solids separation, and reverse osmosis or an adsorbent-based treatment.

In the plant 10, feed wastewater 12, for example distillery spent wash, flows into an equalization tank 14. Equalization tank 14 allows for a generally constant flow of wastewater 12 to a downstream anaerobic digester 16 despite variations in the feed flow rate. The pH and temperature of the wastewater 12 may also be adjusted in the equalization tank 14.

The anaerobic digester 16 receives wastewater 12 from the equalization tank 14. The digester 16 may be, for example, a sealed vessel with an internal mechanical stirrer operated to support biomethanation of the wastewater 12. Anaerobic bacteria in the digester 16 digest organic matter in the wastewater, converting it into a biogas 20, which is primarily methane and carbon dioxide. A liquid effluent 22 is released from the digester 16. The biogas 20 is collected in a headspace of the digester 16 and used as an energy source. For example, the biogas 20 can be burned to produce heat or to drive an engine. In the plant 10, the biogas 20 is burned in a combined heat and power engine, for example a Jenbacher engine from General Electric Company driving an electrical generator to produce electricity and heat. The heat may be used in the distillery or in the plant 10, as will be described below. A liquid recirculation flow 24 may be returned from the digester 16 to the equalization tank 14 to increase the solids retention time of the digester 16. Solids are wasted from the digester 16 or the equalization tank 14 as required to prevent build up in the digester 16.

The digester effluent 22 is sent to a chemical treatment unit 26 where chemicals are added to the digester effluent 22. The chemical treatment unit 26 may be, for example, one or more stirred reactors or inline chemical injection and mixing devices. Chemicals 29 added to the digester effluent 22 are selected to form a floc or precipitates, or both, in the digester effluent. Sludge 28 containing settled flocs or precipitates may be removed directly from the bottom of the chemical treatment unit 26 as shown if the mixing rate allows precipitates or floc to settle. However, floc can be removed more efficiently from the chemical treatment unit 26 by a downstream solid-liquid separation device (not shown) such as a clarifier or settling tank, a dissolved air flotation unit, or a rotary drum system. The chemical treatment reduces one or more of color and suspended impurities such as COD or total suspended solids (TSS). This reduces the load on subsequent unit operations. In particular, if membranes are used in downstream processes, the cost of the chemical precipitation may be recovered in increased flux or reduced fouling in the membranes.

In an embodiment of a chemical treatment process, the digester effluent 22 is treated with a primary coagulant or flocculant chemical such as alum, aluminum chlorohydrate, aluminum sulfate, calcium oxide, cacicium hydroxide, iron (II) sulfate, iron (III) chloride, polyacrylamide, polyDADMAC, sodium aluminate or sodium silicate or a natural product such as Chitosan, Isinglass, Moringa oleifera seeds, gelatin, strychnos potatorum seeds, guar gum, or an alginate. For example, an aqueous solution of an aluminum chlorohydrate and polyDADMAC may be used at a dosage ranging from about 15 mg/liter to about 500 mg/liter. The resultant from that step may be treated with a cationic flocculant at a dosage ranging from about 10 to about 200 mg/liter to help form floc. The cationic flocculant may be polymeric, including copolymers or terpolymers, such as a water soluble cationic terpolymer comprising a quaternary ammonium condensation polymer of epichlorohydrin and diethylamine, a high molecular weight polyquarternized polyamine cationic polymer, or a tannin Mannich condensation polymer or graft copolymer. After the chemicals described above, an anionic water soluble high molecular weight polymer may be added at a dosage ranging from about 1 mg/Liter to 100 mg/liter, to increase the floc size and to cause floc to settle. The anionic polymer may be, for example, an anionic acrylic acid acrylamide copolymer, a partially hydrolyzed acrylamide, or a hydrophobically modified acrylic acid/acrylamide polymer. After the flocculated material is removed, the remaining liquid effluent may be treated with one or more reducing agents such as sodium dithionate, alkaline earth hydrosulfite or a mixture of these. The resulting chemically treated effluent 30 is substantially odor less with less color and TSS than the digester effluent 22.

Some or all of the chemically treated effluent 30 may be sent to an electrocoagulation (EC) unit 32. This step serves to remove some percentage of the residual color and suspended impurities as well as hardness in the wastewater. Treatment of wastewater by EC has been used in the past primarily to treat industrial wastewater from pulp and paper industries, mining and metal-processing industries. In a typical EC process, a coagulant is generated in situ by electrolytic oxidation of an appropriate anode material. In this process, charged ionic species such as metals are removed from wastewater by allowing them to react with an ion having the opposite charge, or with a floc of metallic hydroxides generated within the effluent. Metals, colloidal particles and soluble inorganic pollutants are removed from water by introducing a highly charged polymeric metal hydroxide species. These species neutralize the electrostatic charges on suspended solids and oil droplets to facilitate agglomeration or coagulation and resultant separation from the aqueous phase. The treatment prompts the precipitation of certain metals and salts.

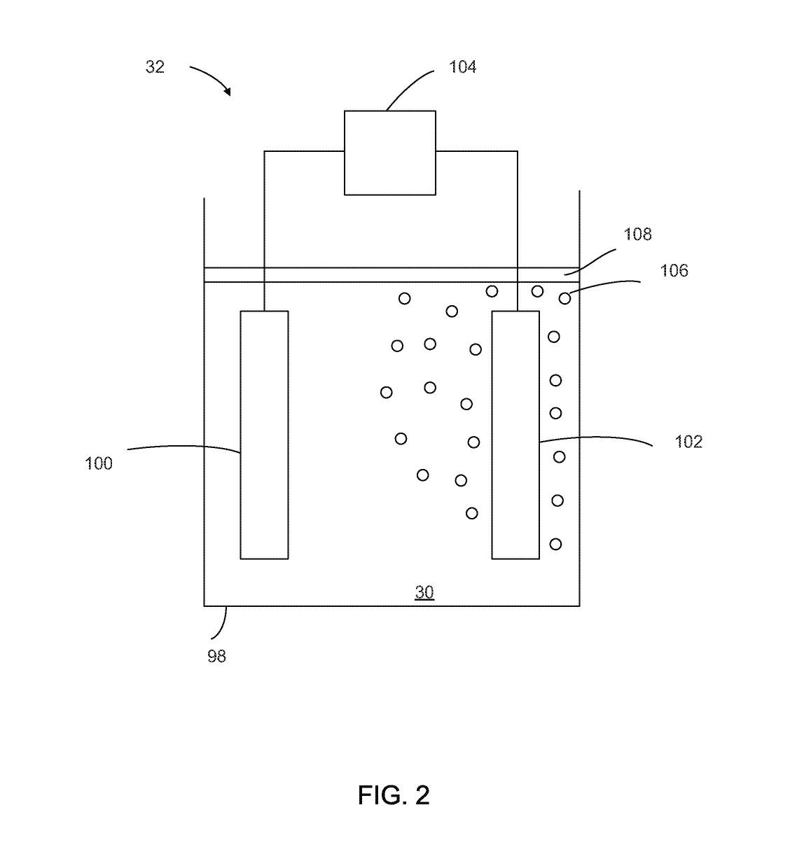

Referring to FIG. 2, the plant 10 uses a DC electrocoagulation system 32 comprising a tank 98 for receiving the chemically treated effluent 30, an anode 100 and a cathode 102. The anode 100 may be made of aluminum and the cathode 102 may be made of stainless steel. A current is applied to the anode 100 and cathode 102 from a DC voltage source 104. For example, the current may be applied at a charge density of about 5-50 mA/cm² for a duration ranging from about 10 min to about 3 hours. This EC system 32 differs from previous systems in the use of a stable inert cathode 102. The EC system 32 provides both electrocoagulation and electroflotation (EF). Electroflotation is achieved when the evolved gases (in the form of small bubbles 106) at the cathode 102 push flocs entering with the chemically treated effluent 30 or produced in the EC system 32 to a floc layer 108 at the top of the solution. The floated flocs may be removed by overflow and simple filtration. The EC system 32 also removes Ca-hardness and total hardness. This is achieved because oxygen reduction occurs at the cathode 102 and produces OH— ions. This process increases the pH near the cathode 102, which may rise to a pH of about 10 or more. The high pH facilitates the precipitation of CaCO³/ MgCO³ on the cathode surface and thereby reduces the Ca hardness and total hardness.

Alternatively, the EC unit 32 may be omitted or partially by-passed. In this case, it may be desirable to reduce the hardness of the chemically treated effluent 30 as required to avoid scaling in the downstream unit processes. The hardness can be reduced by sending a sufficient portion of the chemically treated effluent 30 through the EC unit 32. Alternatively, or additionally, further chemical treatments can be used to reduce hardness. In particular, the chemically treated effluent 30 can be softened by lime softening or other chemical softening methods known in the art.

The chemically treated effluent 30 or an EC effluent 34 or both flow into a membrane bioreactor (MBR) 36. The MBR 36 may have ultrafiltration (UF) or microfiltration (MF) membrane units 38 operated under pressure or suction. The membrane units 38 may be located in a membrane vessel 40 connected through a recycle loop to a process tank 42, although the membrane units 38 may also be immersed directly in the process tank 42. The MBR 36 removes BOD/COD by way of aerobic digestion in the process tank 42 and retention of solids in the mixed liquor by the membrane units 38. Depending on the configuration and operation of the process tanks 42, ammonia and phosphate levels in the wastewater may also be reduced. Membrane units 38 and other MBR 36 components are available from GE Water and Process Technologies as sold, for example, under the ZeeWeed trademark. Due to the membrane barrier, the TSS concentration of the wastewater is reduced and there is a decrease in the residual color. With little COD and TSS concentration, an MBR permeate 42 withdrawn from the membrane units 38 is suitable for further treatment as will be described below.

The permeate 42 still contains a small amount of residual colour and roughly half of the hardness and total dissolved solids (TDS) of the digester effluent 22. The permeate 42 may be further treated to remove one or more of the remaining hardness, TDS and color depending on requirements for reuse of the wastewater or discharge requirements. If hardness removal is required, then the MBR permeate 42 may be sent to a nanofiltration or RO membrane unit 44. This produces a permeate 46 which may be the final effluent from the plant 10. A retentate or reject stream 48 is also produced. Optionally, waste heat 50 from the engine 18 may be used to dewater the reject stream 48. RO membrane systems are available from GE Water & Process Technologies under the Titan and PRO trade marks.

Alternatively, if only TDS and color are to be removed, the MBR permeate 42 may be sent through an adsorption column 52. The adsorption column 52 contains a packed bed of adsorbent material, for example activated carbon, polyvinyl chloride or cellulose acetate phthalate. Alternatively, the adsorption column may be packed with cationically modified bagasse, the fibrous residue left after the sugar juice is removed from sugar cane. The bagasse may be crushed, for example to a particle size averaging about 0.2 mm, and treated with an acid and an aldehyde. Bagass may be useful in a case where the plant 10 is used to treat waste from a molasses based distillery that produces bagasse as a by-product and the plant 10 is used to treat 100 m³/day or more of wastewater 12.

Table 2 shows the concentration of various contaminants in digester effluent obtained from a molasses based distillery after laboratory scale tests. The tests applied chemical treatment, electrocoagulation, treatment in a membrane bioreactor and reverse osmosis sequentially to the digester effluent as described above to demonstrate the effect of processes described above that may be used in the plant 10. The concentrations of contaminants given in the columns of Table 2 are concentrations in ppm measured in the effluent from the stage named at the top of each column.

TABLE 2
Contaminant Concentration in Effluent From Stages of Treatment

| | | Chemical | Electro- | | |
|---|---|---|---|---|---|
| Contaminant | Digester | Treatment | Coagulation | MBR | RO |
| COD | 15664 | 10808 | 8200 | 800 | 110 |
| BOD | 10417 | 6250 | 5211 | 0.4 | 0.1 |
| Total hardness | 5925 | 2448 | 630 | 340 | 21 |
| Calcium hardness | 2960 | 1036 | 420 | 200 | 8 |
| TSS | 7400 | 2830 | 620 | 0.1 | 0 |
| TDS | 23463 | 16182 | 11000 | 11513 | 412 |

In the example of Table 2, the digester had a dark brown color that became lighter after each stage. The final effluent after reverse osmosis was essentially colorless. The final effluent was of sufficient quality to be reused in the distillery.

The final process step in the example of Table 2 used RO membranes. Approximately one half, or more, of the color causing pigments initially present in MSW are in the soluble range. However, as indicated in Table 2, a significant portion of the color has already been removed upstream of the RO membranes. It may be possible to use nanofiltration (NF) membranes in place of RO membranes and achieve acceptable total color removal while decreasing the amount of reject 48. In an embodiment, a multi stage final process may be used with NF membranes in front of RO membranes or NF membranes in front of an adsorption unit.

Other modifications to the process and apparatus described above for plant 10 may also be made within the scope of one or more embodiments of the invention described above. The scope of the embodiments of the invention protected by this document is defined by the following claims. Other embodiments of the invention may be claimed in further or related applications or patents.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A process for treating effluent from an anaerobic digester fed with molasses spent wash, the process comprising:
adding flocculant chemicals to the effluent;
removing flocs or precipitates from the effluent;
reducing the hardness of the effluent;
treating the effluent by aerobic digestion of the effluent; and
treating the effluent by membrane separation or adsorption.

2. The process of claim 1, wherein the hardness of the effluent is reduced by treating the effluent in an electrocoagulation unit with a stable cathode.

3. The process of claim 2, wherein the cathode is made of stainless steel.

4. The process of claim 1, wherein the effluent is digested in a membrane bioreactor.

5. The process of claim 1, wherein treating the effluent by membrane separation or adsorption further comprises passing the effluent through a nanofiltration or reverse osmosis membrane.

6. The process of claim 5, wherein treating the effluent by membrane separation or adsorption further comprises passing the effluent through a nanofiltration membrane and then through a reverse osmosis membrane or packed bed adsorption column.

7. The process of claim 1, wherein treating the effluent by membrane separation or adsorption further comprises passing the effluent through an adsorption column.

8. The process of claim 7, wherein the adsorption column contains a packed bed comprising bagasse.

9. The process of claim 1, wherein adding flocculant chemicals to the effluent and removing flocs or precipitates from the effluent, further comprises treating the effluent with a coagulant, a cationic flocculant and an anionic flocculant.

10. The process of claim 1, wherein adding flocculant chemicals to the effluent and removing flocs or precipitates from the effluent, further comprises treating the effluent with a water soluble cationic polymer selected from the group of a quaternary ammonium condensation polymer of epichlorohydrin and diethylamine, a high molecular weight polyquarternized polyamine cationic polymer, and a tannin Mannich condensation polymer or graft copolymer.

11. The process of claim 1, wherein adding flocculant chemicals to the effluent and removing flocs or precipitates from the effluent, further comprises treating the effluent with a water soluble anionic polymer selected from the group of an anionic acrylic acid acrylamide copolymer, a partially hydrolyzed acrylamide, and a hydrophobically modified acrylic acid or an acrylamide polymer.

12. The process of claim 1, wherein adding flocculant chemicals to the effluent and removing flocs or precipitates from the effluent, further further comprises treating the effluent with a reducing agent.

13. A process for treating a wastewater, the process comprising:
adding chemicals to the wastewater to produce flocs in the wastewater and removing the flocs;
treating the wastewater by electrocoagulation;
treating the wastewater in a membrane bioreactor; and
treating the wastewater by at least one or more of nanofiltration, reverse osmosis and adsorption.

14. The process of claim 13, wherein the treating the wastewater by electrocoagulation is performed with a stable cathode.

15. The process of claim 13, wherein treating the wastewater by at least one of nanofiltration, reverse osmosis and adsorption, further comprises treating the waste water by adsorption in a packed bed comprising bagasse.

16. A process for treating effluent from an anaerobic digester fed with molasses spent wash comprising a step of passing the effluent through an electrocoagulation unit having a stable cathode.
